(19) United States
(12) Patent Application Publication
(10) Pub. No.: US 2017/0139488 A1
(43) Pub. Date: May 18, 2017

(54) METHOD, APPARATUS AND SYSTEM FOR INPUTTING CHARACTER

(71) Applicant: Xiaomi Inc., Beijing (CN)

(72) Inventors: Ke Wang, Beijing (CN); Jianquan Liu, Beijing (CN); Le Wang, Beijing (CN)

(21) Appl. No.: 15/196,577

(22) Filed: Jun. 29, 2016

(30) Foreign Application Priority Data
Nov. 13, 2015 (CN) 201510777567.4

(51) Int. Cl. G06F 3/023; G06F 3/0346

(52) U.S. Cl. CPC G06F 3/0238; G06F 3/0346; G06F 3/0233

(57) ABSTRACT

A method for inputting a character is provided. The method includes: receiving a first character input by a user; determining a character set associated with the first character, the character set including a second character; obtaining a key identifier corresponding to the second character based on a corresponding relationship between the second character and the key identifier; and causing a key light corresponding to a key identified by the key identifier to emit light with a preset color.

### CROSS-REFERENCE TO RELATED APPLICATION

This application is based upon and claims priority to Chinese Patent Application No. 201510777567.4, filed Nov. 13, 2015, the entire contents of which are incorporated herein by reference.

### TECHNICAL FIELD

The present disclosure generally relates to the field of electronic device and, more particularly, to a method, an apparatus and a system for inputting a character.

### BACKGROUND

Keyboard is a common input device used in a terminal device for interaction between a user and the terminal device. For example, the user may input characters, such as letters, numbers, Chinese characters, and punctuation marks, into the terminal device via a keyboard.

### SUMMARY

According to a first aspect of the present disclosure, there is provided a method for inputting a character, comprising: receiving a first character input by a user; determining a character set associated with the first character, the character set including a second character; obtaining a key identifier corresponding to the second character based on a corresponding relationship between the second character and the key identifier; and causing a key light corresponding to a key identified by the key identifier to emit light with a preset color.

According to a second aspect of the present disclosure, there is provided a method for inputting a character, comprising: receiving an instruction to turn on a key light, the instruction including a second character, and the second character being included in a character set associated with a first character input by a user; obtaining a key identifier corresponding to the second character based on a corresponding relationship between the second character and the key identifier; and causing a key light corresponding to a key identified by the key identifier to emit light with a preset color.

According to a third aspect of the present disclosure, there is provided a device for inputting a character, comprising: a processor; and a memory for storing instructions executable by the processor. The processor is configured to: receive a first character input by a user; determine a character set associated with the first character, the character set including a second character; obtain a key identifier corresponding to the second character based on a corresponding relationship between the second character and the key identifier; and cause a key light corresponding to a key identified by the key identifier to emit light with a preset color.

According to a fourth aspect of the present disclosure, there is provided a device for inputting a character, comprising: a processor; and a memory for storing instructions executable by the processor. The processor is configured to: receive an instruction to turn on a key light, the instruction including a second character, and the second character being included in a character set associated with a first character input by a user; obtain a key identifier corresponding to the second character based on a corresponding relationship between the second character and the key identifier; and cause a key light corresponding to a key identified by the key identifier to emit light with a preset color.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1-1 is a schematic diagram illustrating a system environment, according to an exemplary embodiment.

FIG. 1-2 is a schematic diagram illustrating a terminal device, according to an exemplary embodiment.

FIG. 1-3 is a schematic diagram illustrating a front view of a keyboard, according to an exemplary embodiment.

FIG. 1-4 is a schematic diagram illustrating a cross-sectional view of a keyboard, according to an exemplary embodiment.

FIG. 1-5 is a schematic diagram illustrating another terminal device, according to an exemplary embodiment.

FIG. 1-6 is a schematic diagram illustrating a cross-sectional view of a terminal device, according to an exemplary embodiment.

FIG. 2 is a flowchart of a method for inputting a character, according to an exemplary embodiment.

FIG. 3 is a flowchart of another method for inputting a character, according to an exemplary embodiment.

FIG. 4 is a flowchart of another method for inputting a character, according to an exemplary embodiment.

FIG. 5-1 is a flowchart of another method for inputting a character, according to an exemplary embodiment.

FIG. 5-2 is a flowchart of a method for determining a character set, according to an exemplary embodiment.

FIG. 5-3 is a flowchart of a method for controlling a key light, according to an exemplary embodiment.

FIG. 5-4 is a schematic diagram illustrating a key light control, according to an exemplary embodiment.

FIG. 5-5 is a flowchart of another method for controlling a key light, according to an exemplary embodiment.

FIG. 5-6 is a schematic diagram illustrating a key light control, according to an exemplary embodiment.

FIG. 5-7 is a flowchart of another method for controlling a key light, according to an exemplary embodiment.

FIG. 5-8 is a schematic diagram illustrating a key light control, according to an exemplary embodiment.

FIG. 5-9 is a flowchart of another method for controlling a key light, according to an exemplary embodiment.

FIG. 5-10 is a flowchart of another method for controlling a key light, according to an exemplary embodiment.

FIG. 5-11 is a schematic diagram illustrating a key light control, according to an exemplary embodiment.

FIG. 5-12 is a flowchart of a method for controlling a key light, according to an exemplary embodiment.

FIG. 5-13 is a flow diagram of a method for updating a wordbook, according to an exemplary embodiment.

FIG. 5-14 is a flowchart of another method for updating a wordbook, according to an exemplary embodiment.

FIG. 6-1 is a flow diagram of another method for inputting a character, according to an exemplary embodiment.

FIG. 6-2 is a flowchart of another method for determining a character set, according to an exemplary embodiment.

FIG. 6-3 is a flowchart of a method for controlling a key light, according to an exemplary embodiment.

FIG. 6-4 is a flowchart of another method for controlling a key light, according to an exemplary embodiment.

FIG. 6-5 is a flowchart of another method for controlling a key light, according to an exemplary embodiment.

FIG. 6-6 is a flowchart of another method for controlling a key light, according to an exemplary embodiment.

FIG. 6-7 is a flowchart of another method for controlling a key light, according to an exemplary embodiment.

FIG. 6-8 is a flowchart of another method for controlling a key light, according to an exemplary embodiment.

FIG. 7 is a block diagram of an apparatus for inputting a character, according to an exemplary embodiment.

FIG. 8 is a block diagram of another apparatus for inputting a character, according to an exemplary embodiment.

FIG. 9 is a block diagram of another apparatus for inputting a character, according to an exemplary embodiment.

FIG. 10 is a block diagram of another apparatus for inputting a character, according to an exemplary embodiment.

FIG. 11 is a block diagram of another apparatus for inputting a character, according to yet an exemplary embodiment.

FIG. 12 is a block diagram of a device for inputting a character, according to an exemplary embodiment.

FIG. 13 is a block diagram of another device for inputting a character, according to an exemplary embodiment.

FIG. 14 is a block diagram of a system for inputting a character, according to an exemplary embodiment.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

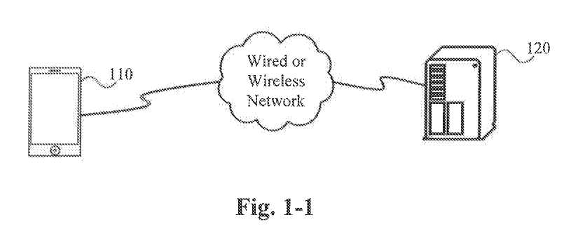

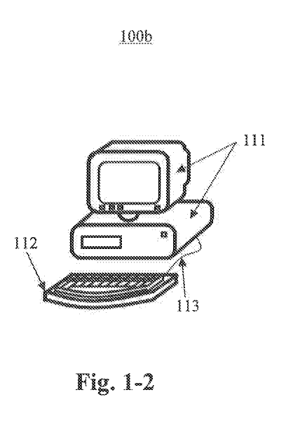

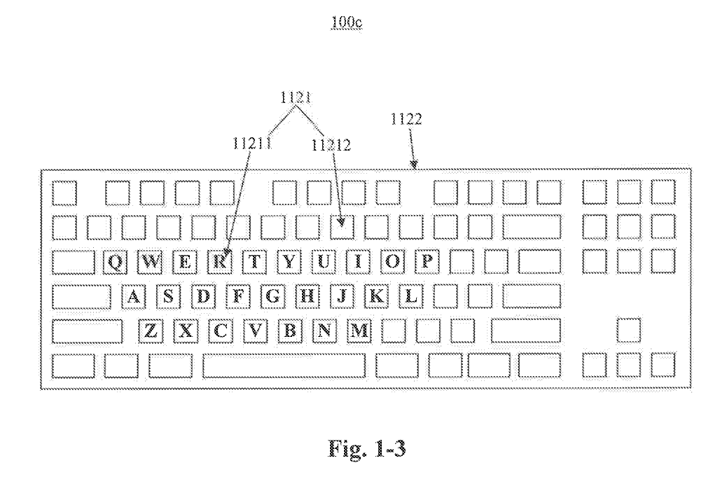

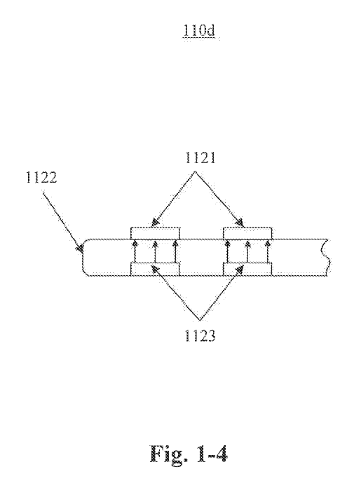

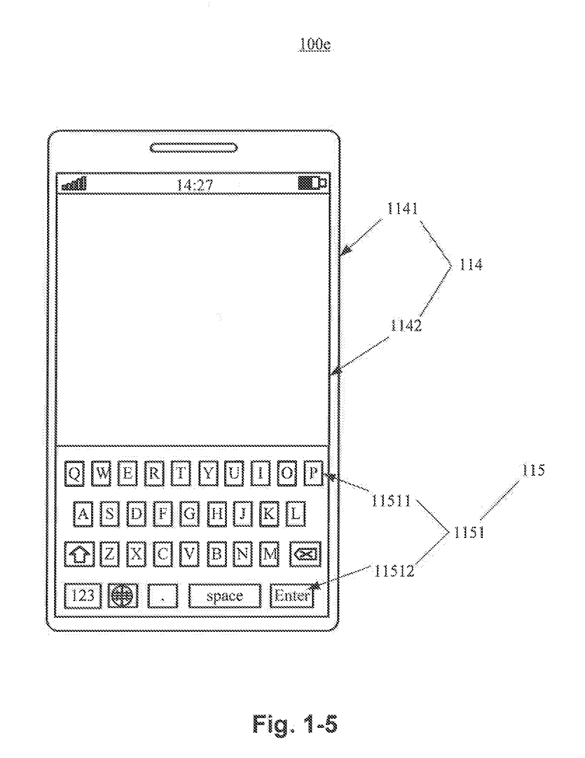

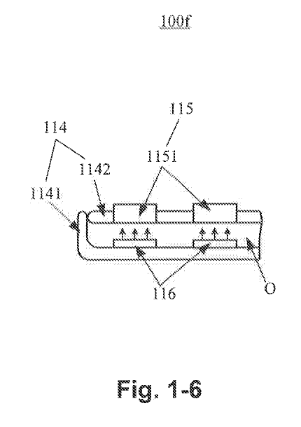

FIG. 1-1 is a schematic diagram illustrating a system environment 100a, according to an exemplary embodiment. Referring to FIG. 1-1, the system environment 100a includes a terminal device 110 and a server 120, which may communicate via a wired or wireless network such as a WIFI, Blue Tooth, infrared, or ZigBee network.

In some embodiments, the terminal device 110 is provided with a keyboard, and a user may input characters to the terminal device 110 via the keyboard. For example, the terminal device may be a mobile phone, a desktop computer, a portable laptop computer, a notebook computer, a smart television, a smart wearable device and the like. The server 120 may be a single server, a server group consisting of several servers, or a cloud-computing service center, which is not limited by the present disclosure.

The terminal device 110 and the server 120 may each store a wordbook including relationships between various characters, and the wordbook stored in the server 120 may be more comprehensive than that stored in the terminal device 110. When a relationship between characters of certain words is not recorded in the wordbook stored in the terminal device 110, the terminal device 110 may interact with the server 120 to update the wordbook stored in the terminal device 110.

In some embodiments, the terminal device 110 may include a keyboard having a keyboard light. The terminal device 110 may adjust the color and/or intensity of the light emitted by the keyboard light. For example, when a user inputs characters via the keyboard, the terminal device 110 may turn the keyboard light on, such that the light emitted by the keyboard light may provide convenience for the user when inputting. The terminal device 110 may adjust the color of the light emitted by the keyboard light according to a brightness of the light of the environment of the user, so as to provide a suitable light for the user.

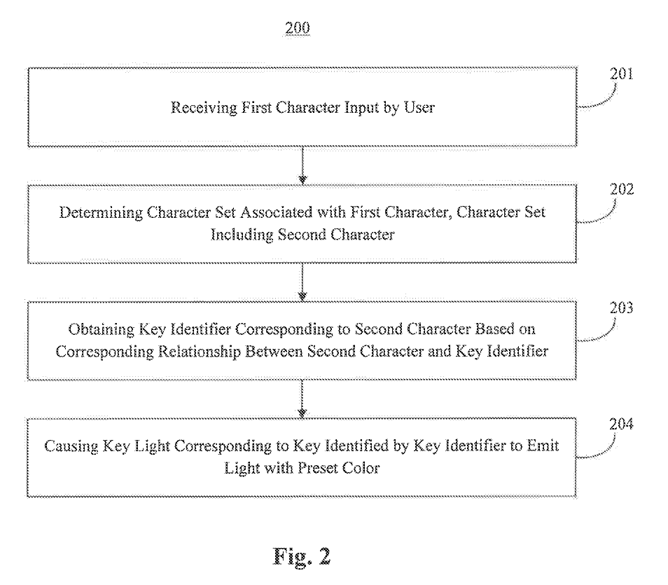

FIG. 1-2 is a schematic diagram 110b illustrating a terminal device, according to an exemplary embodiment. As shown in FIG. 1-2, in this example, the terminal device 110 is a computer. Referring to FIG. 1-2, the terminal device 110 includes a body 111 and a keyboard 112 connected to the body 111. The keyboard 112 is connected with the body 111 via a connector 113. In some implementations, a universal serial bus (USB) interface may be used between the keyboard 112 and the body 111.

FIG. 1-3 is a schematic diagram 100c illustrating a front view of a keyboard, according to an exemplary embodiment. Referring to FIG. 1-3, the keyboard 112 may include one or more keys 1121, and each key 1121 may correspond to a key light (not shown in FIG. 1-3) for illuminating the key 1121. As shown FIG. 1-3, the keyboard 112 may include a housing 1122, and the keys 1121 are provided on the housing 1122. Referring to FIG. 1-3, the keys 1121 include character keys 11211 and function keys 11212. The character keys 11211 may be keys for letters or etymons, while the function keys 11212 are keys other than the character keys 11211. For example, the function keys 11212 may include keys for numbers, punctuation marks and space bars, which is not limited by the present disclosure.

FIG. 1-4 is a schematic diagram 110d illustrating a cross-sectional view of a keyboard, according to an exemplary embodiment. Referring to FIG. 1-4, the keyboard 112 may include the housing 1122 and the one or more keys 1121 provided on the housing 1122 (two keys are shown in FIG. 1-4), and each key 1121 may correspond to a key light 1123. When being turned on, the key light 1123 can illuminate the corresponding key 1121. For example, the key light 1123 may be placed inside the housing 1122 and located under the corresponding key 1121.

FIG. 1-5 is a schematic diagram 100e illustrating another terminal device, according to an exemplary embodiment. As shown in FIG. 1-5, in this example, the terminal device 110 is a mobile phone. Referring to FIG. 1-5, the terminal device 110 may include a body 114 and a keyboard 115 connected to the body 114. For example, the body 114 may include a housing 1141 and a board 1142 provided on the housing 1141, and the keyboard 115 is provided on the board 1142.

The keyboard 115 may include one or more keys 1151, and each key 1151 may correspond to a key light (not shown in FIG. 1-5) for illuminating the corresponding key 1151. As shown in FIG. 1-5, the one or more keys 1151 may include character keys 11511 and function keys 11512. The character keys 11511 may be keys for entering letters or etymons, while the function keys 11512 are keys other than the character keys 11511. For example, the function keys 11512 may include keys for entering numbers, punctuation marks and space bars. In some embodiments, the keyboard 115 also may be a virtual keyboard displayed in a display screen of the terminal device.

FIG. 1-6 is a schematic diagram 100f illustrating a cross-sectional view of a terminal device, according to an exemplary embodiment. Referring to FIG. 1-6, the body 114 may include the housing 1141 and the board 1142 provided on the housing 1141. The keyboard 115 is provided on the board 1142, and one or more key lights 116 may be provided inside the housing 1141 and located between the housing 1141 and the corresponding key 1151.

As shown in FIG. 1-6, a cavity O may be formed between the housing 1141 and the board 1142, and the cavity O may be configured to hold a processing chip or other hardware structures of the terminal device 110.

FIG. 2 is a flowchart of a method 200 for inputting a character, according to an exemplary embodiment. The method 200 may be performed by a terminal device, such as the terminal device 110 shown in FIG. 1-1. Referring to FIG. 2, the method 200 may include following steps.

In step 201 the terminal device receives a first character input by a user.

In step 202, the terminal device determines a character set associated with the first character, the character set including a second character.

In step 203, the terminal device obtains a key identifier corresponding to the second character based on a corresponding relationship between the second character and the key identifier.

In step 204, the terminal device causes a key light corresponding to a key identified by the key identifier to emit light with a preset color. For example, the light may be used for prompting the user to input the character corresponding to the key identified by the key identifier.

In the method 200, by causing the key light corresponding to the key identified by the key identifier to emit light, the input efficiency of the user may be improved and the input error of the user may be reduced.

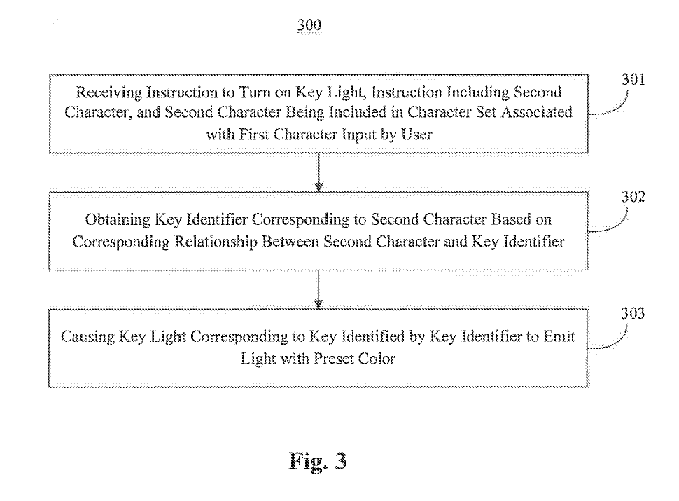

FIG. 3 is a flowchart of another method 300 for inputting a character, according to an exemplary embodiment. The method 300 may be performed by a terminal device, such as the terminal device 110 shown in FIG. 1-1. Referring to FIG. 3, the method 300 may include the following steps.

In step 301, the terminal device receives an instruction to turn on a key light, the instruction including a second character, and the second character being included in a character set associated with a first character input by a user.

In step 302, the terminal device obtains a key identifier corresponding to the second character based on a corresponding relationship between the second character and the key identifier.

In step 303, the terminal device causes a key light corresponding to a key identified by the key identifier to emit light with a preset color. For example, the light may be used for prompting the user to input the character corresponding to the key identified by the key identifier.

In the method 300, by causing the key light corresponding to the key identified by the key identifier to emit light, the input efficiency of the user may be improved and the input error of the user may be reduced.

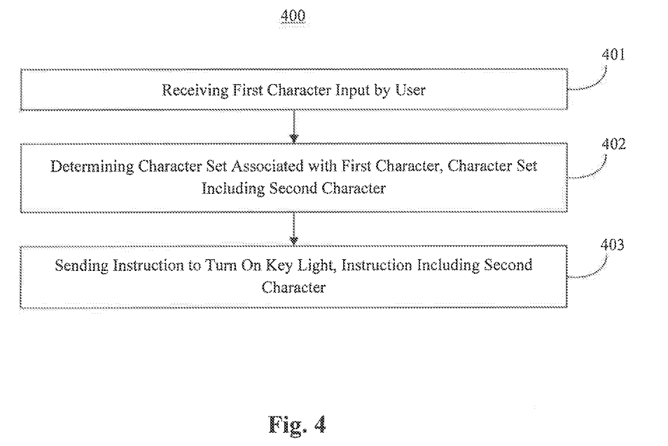

FIG. 4 is a flowchart of another method 400 for inputting a character, according to an exemplary embodiment. The method 400 may be performed by a terminal device, such as the terminal device 110 shown in FIG. 1-1. Referring to FIG. 4, the method 400 may include the following steps.

In step 401, the terminal device receives a first character input by a user.

In step 402, the terminal device determines a character set associated with the first character, the character set including a second character.

In step 403, the terminal device sends an instruction to turn on a key light, the instruction including the second character. For example, a keyboard may obtain a key identifier corresponding to the second character according to the instruction, and cause a key light corresponding to a key identified by the key identifier to emit light with a preset color for prompting the user to input the second character.

In the method 400, by causing the key light corresponding to the key identified by the key identifier to emit light, the input efficiency of the user may be improved and the input error of the user may be reduced.

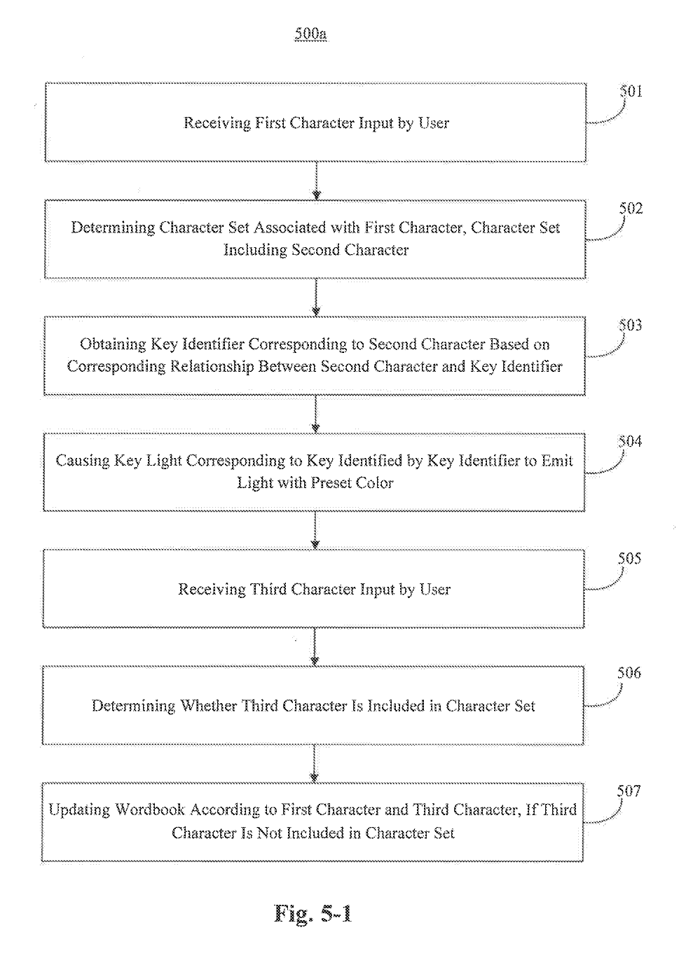

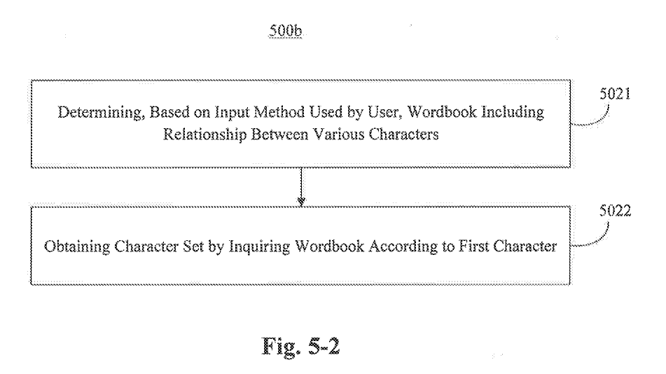

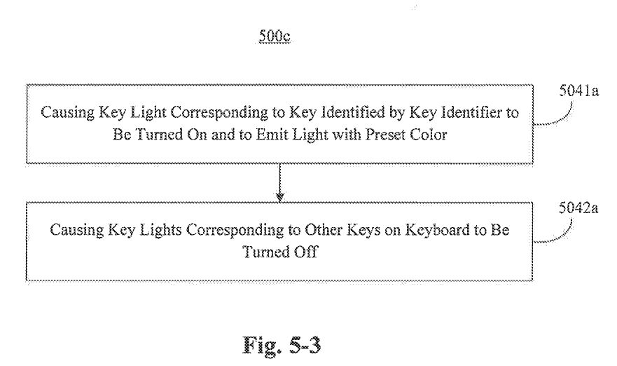

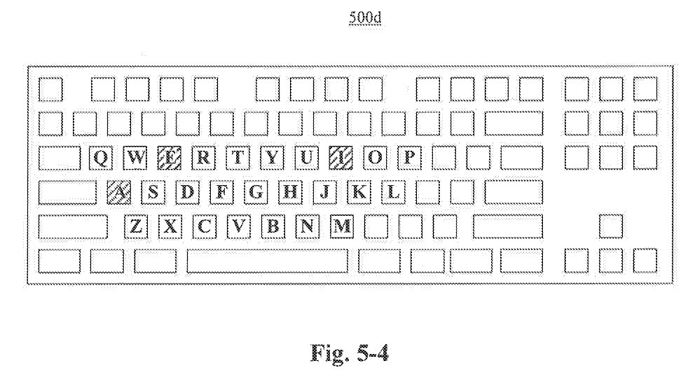

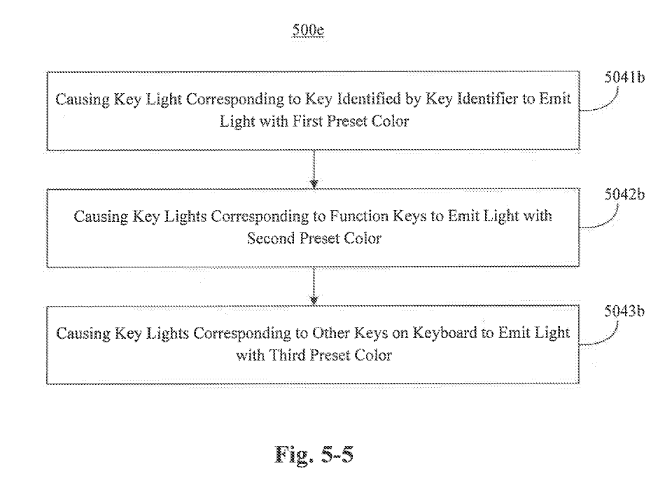

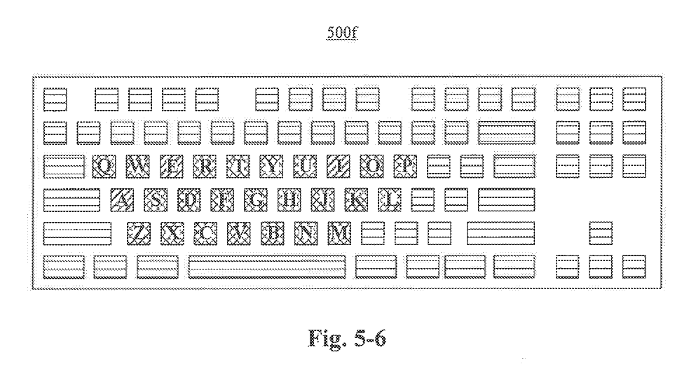

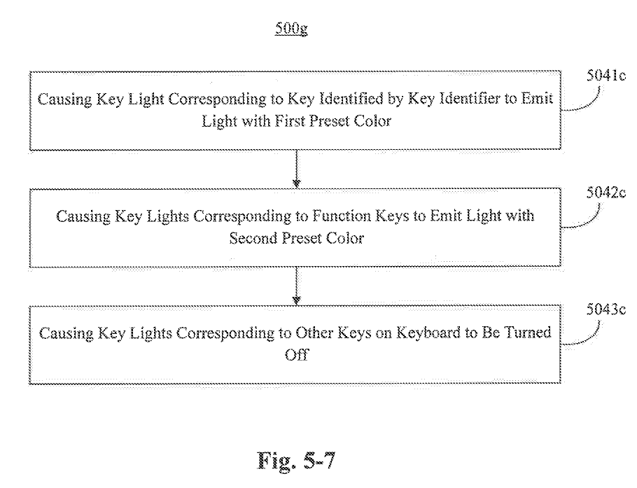

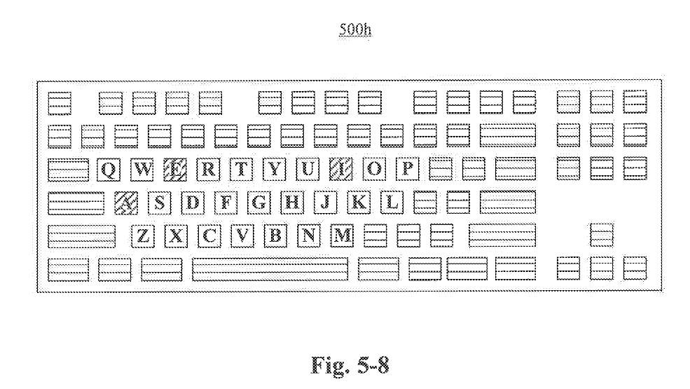

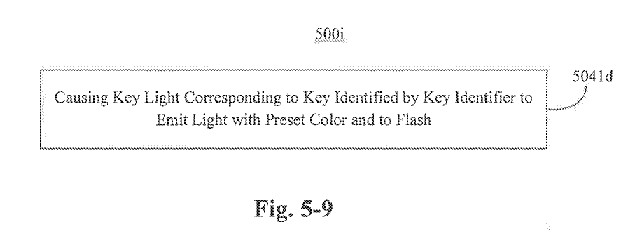

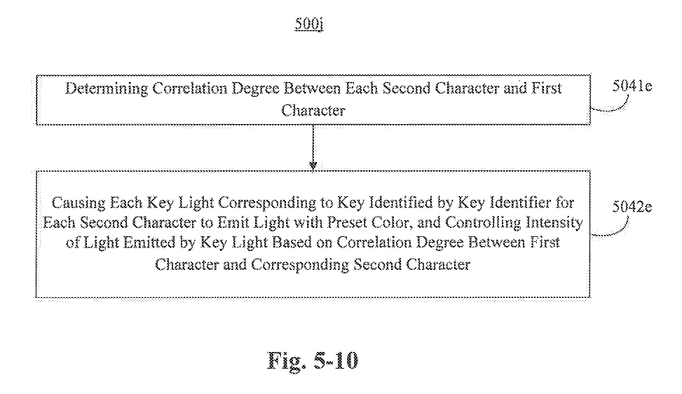

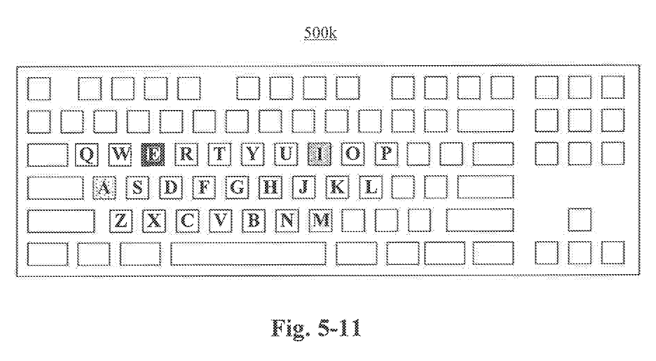

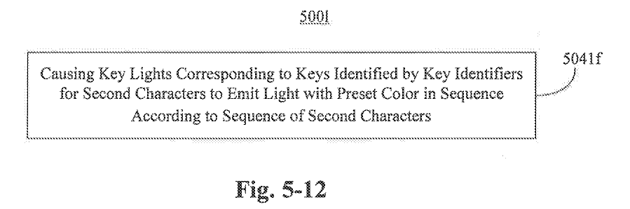

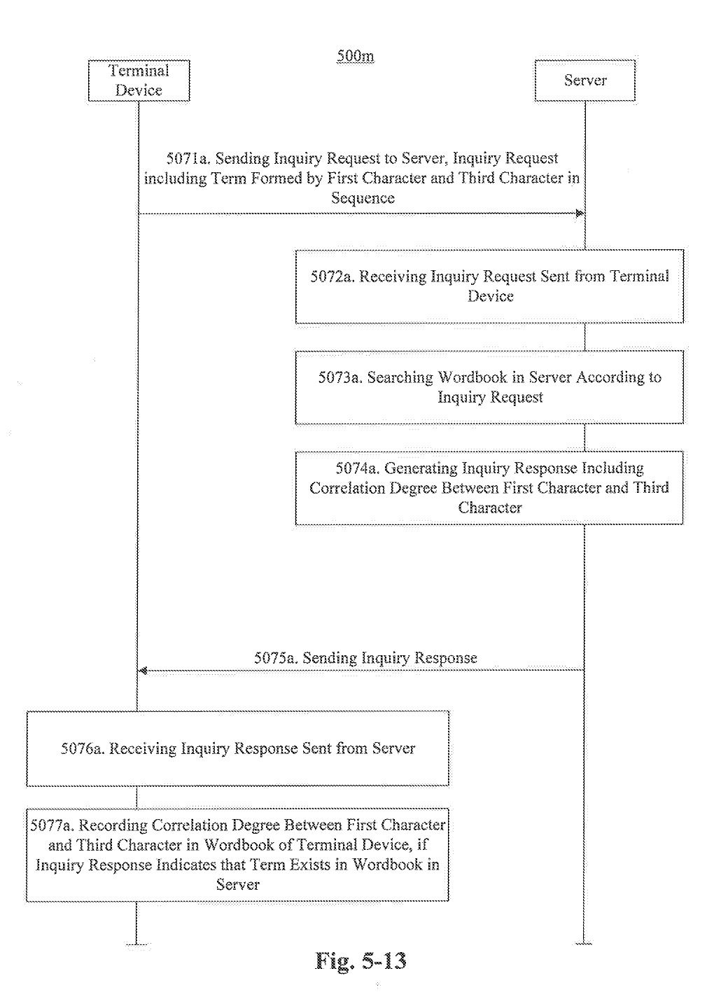

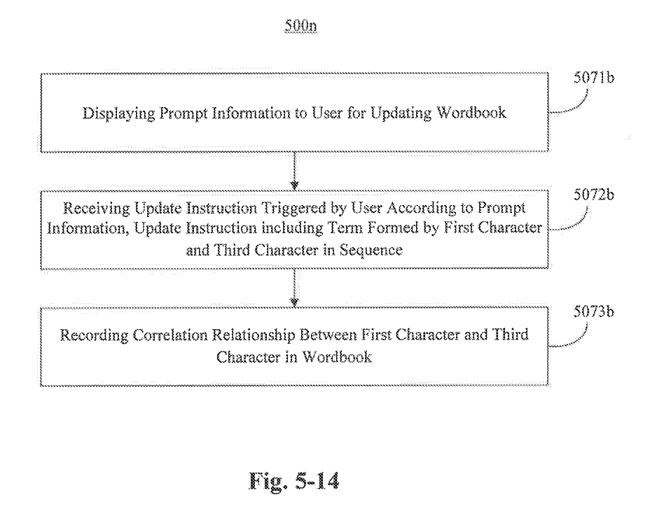

FIG. 5-1 is a flowchart of another method 500a for inputting a character, according to an exemplary embodiment. The method 500a may be performed by a terminal device, such as a processor of the terminal device, a keyboard of the terminal device, a processor integrated in the keyboard, or the like. For example, the keyboard may be an external device of a terminal device and include a processor or an integrated circuit (IC). The processor or IC can communicate with a processor of the terminal device via an input/output interface of the terminal device. As another example, the keyboard may be an internal device of the terminal device and include an independent processor or a processing IC. The processor or IC may be connected to the processor of the terminal device. Referring to FIG. 5-1, the method 500a may include the following steps.

In step 501, the terminal device receives a first character input by a user. For example, the first character may include a letter or a stroke, which is not limited by the present disclosure.

In some embodiments, a character input instruction may be triggered by the user operating character keys on the keyboard of the terminal device. The character input instruction may include a character corresponding to on the key operated by the user, and this character is referred to as the first character. The terminal device may receive and analyze the character input instruction to obtain the first character.

For example, referring to FIG. 1-3, assuming the key currently operated by the user is a key having a character “h” on the keyboard 112, the character input instruction triggered by the user may include the character “h”, the terminal device may analyze the character input instruction to obtain the character “h” as the first character.

In step 502, the terminal device determines a character set associated with the first character, the second character set including a second character.

In some embodiments, a type of the second character is identical with that of the first character. For example, if the type of the first character is a letter, then the type of the second character is a letter, and if the type of the first character is a stroke, then the type of the second character is a stroke.

FIG. 5-2 is a flowchart of a method 500b for determining a character set associated with a first character by a terminal device, according to an exemplary embodiment. Referring to FIG. 5-2, the method 500b may include the following steps.

In sub-step 5021, the terminal device, based on an input method used by the user, determines a wordbook including a relationship between various characters. In some embodiments, the wordbook may be established by words input by the user.

For example, different input methods may correspond to different wordbooks, and thus the character set associated with the first character may be different. The input method may include Five Strokes Input, Sogou Input, Baidu Input, Pinxin Input, or the like, which is not limited by the present disclosure.

In some embodiments, before inputting the first character to the terminal device, the user may select an input method. For example, the user may trigger an input method selecting instruction including an input method selected by the user, and the terminal device may receive the input method selecting instruction and obtain the input method selected by the user. The terminal device may store a corresponding relationship between an input method and a wordbook. When obtaining the input method selected by the user, the terminal device may obtain the wordbook based on the corresponding relationship between the input method and the wordbook stored in the terminal device. Table 1 illustrates an example corresponding relationship between an input method and a wordbook stored in the terminal device

TABLE 1

| Input Method | Wordbook |
|---|---|
| Five Strokes Input | Wordbook 1 |
| Baidu Input | Wordbook 2 |
| Sogou Input | Wordbook 3 |
| Pinxin Input | Wordbook 4 |
| . . . | . . . |

For example, assuming the input method selected by the user is Sogou Input, the terminal device may determine that the wordbook corresponding to the input method is Wordbook 3 according to the corresponding relationships shown in Table 1.

In sub-step 5022, the terminal device obtains the character set by inquiring the wordbook according to the first character.

For example, the terminal device may inquire wordbook 3 according to the first character “h” to obtain the character set.

In some embodiments, the wordbook may store characters and correlation degrees between different characters. Table 2 illustrates an example wordbook.

TABLE 2
(Wordbook 3)

| First | Second | | Possibly Corresponding |
|---|---|---|---|
| Character | Character | Correlation Degree | Word |
| h | e | 90% | hello |
| | i | 60% | hi |
| | a | 20% | ha |
| a | m | 100% | am |
| | i | 80% | ai |
| | t | 50% | at |
| . . . | . . . | . . . | . . . |

For example, the terminal device may inquire the wordbook 3 shown in Table 2 according to the first character “h” to obtain the character set including the characters “e”, “i” and “a”, in which a correlation degree between the character “e” and the first character “h” is 90%, a correlation degree between the character “i” and the first character “h” is 60%, and a correlation degree between the character “a” and the first character “h” is 20%. The characters “e”, “i”, and “a” may each be referred to as a second character. The wordbook 3 may also store a word “hello” formed by arranging the first character “h” and the second character “e” in a sequence, a word “hi” formed by arranging the first character “h” and the second character “i” a sequence, and a word “ha” formed by arranging the first character “h” and the second character “a” in a sequence.

It some embodiments, the terminal device may adjust the correlation degree between characters according to an input habit of the user. For example, referring to Table 2 above, when detecting that a probability of the word “hi” input by the user within a certain period of time is relatively higher, the terminal device may increase the correlation degree between the second character “i” and the first character “h” to 100%.

It also should be understood that, the wordbook provided in the embodiments of the present disclosure is exemplary, which is not intended to limit the present disclosure. The wordbook may include a greater number of characters than the number shown in Table 2. It also should be understood that the first character and the second character may be a stroke (e.g., etymon), such as a stroke of a Chinese character. For example, after obtaining the first character, the terminal device may determine a first Chinese character corresponding to the first character, then determine a second Chinese character capable of forming a word with the first Chinese character, and determine an etymon of the second Chinese character as the second character. When the first character is a stroke, the second character may be determined by performing methods known in the art, which will not be elaborated herein.

Referring back to FIG. 5-1, in step 503, the terminal device obtains a key identifier corresponding to the second character based on a corresponding relationship between the second character and the key identifier. Table 3 illustrates an example corresponding relationship between a character and a key identifier stored in the terminal device.

TABLE 3

| Character | Key Identifier |
|---|---|
| a | ID-A |
| b | ID-B |
| e | ID-E |
| i | ID-I |
| h | ID-H |
| . . . | . . . |

For example, the terminal device inquiries the corresponding relationship shown in Table 3 to obtain that the key identifier corresponding to the second character “e” is ID-E, the key identifier corresponding to the second character “i” is ID-I, and the key identifier corresponding to the second character “a” is ID-A.

In step 504, the terminal device causes a key light corresponding to a key identified by the key identifier to emit light with a preset color. For example, the light may be used for prompting the user to input the character corresponding to the key identified by the key identifier. The terminal device may first identify the key light corresponding to the key identified by the key identifier, and then control the key light to emit light with the preset color.

In some embodiments, the terminal device may also store a corresponding relationship between a key identifier and a key light identifier. The terminal device may obtain the key light identifier based on the corresponding relationship between the key identifier and the key light identifier, and control the key light identified by the key light identifier to emit light with the preset color. Table 4 illustrates an example corresponding relationship between a key identifier and a key light identifier stored in the terminal device.

TABLE 4

| Key Identifier | Key Light Identifier |
|---|---|
| ID-A | ID-1 |
| ID-B | ID-2 |
| ID-E | ID-3 |
| ID-I | ID-4 |
| ID-H | ID-5 |
| . . . | . . . |

For example, assuming the character set includes three characters having key identifiers ID-E, ID-I, and ID-A, respectively, the terminal device may inquire the corresponding relationship shown in Table 4 to obtain that the key light identifier corresponding to the key identifier ID-E is ID-3, the key light identifier corresponding to the key identifier ID-I is ID-4, and the key light identifier corresponding to the key identifier ID-A is ID-1. Correspondingly, the terminal device may control the key light identified by the key light identifier ID-3, the key light identified by the key light identifier ID-4 and the key light identified by the key light identifier ID-1 to emit light with the preset color.

The preset color may be yellow, green, red, white, blue and the like, which is not limited by the present disclosure. In some embodiments, each key corresponds to a key light, and the colors of the lights emitted by two key lights may be identical or different, which is not limited by the present disclosure. The terminal device may control the key light corresponding to the key identified by the key identifier to be turned on and to emit light with the preset color. The terminal device may control key lights corresponding to keys other than the key identified by the key identifier to be turned off, such that a light difference between the key identified by the key identifier and other keys on the keyboard is relatively apparent, thus operating as a prompt for the user. In some embodiments, the terminal device may control the color of the light emitted by the key light corresponding to the t key identified by the key identifier to be different from the color of the light emitted by other key lights, so as to prompt the user to input the key identified by the key identifier. In some embodiments, the terminal device may control the key light corresponding to the key identified by the key identifier to emit the light with the preset color and to flash to prompt the user to input the key identified by the key identifier. In some embodiments, the terminal device may control the intensity of the light emitted by the key light corresponding to the key identified by the key identifier to prompt the user to input the key identified by the key identifier. In some embodiments, the terminal device may identify a plurality of second characters and may control the key light corresponding to the key identified by the key identifier corresponding to each second character to emit light with the preset color in a sequence according to the sequence of the characters so as to prompt for the user to input the characters.

FIG. 5-3 is a flowchart of a method 500c for controlling a key light, according to an exemplary embodiment. Referring to FIG. 5-3, the method 500c may include the following steps.

In sub-step 5041a, the terminal device causes the key light corresponding to the key identified by the key identifier to be turned on and to emit light with the preset color.

In some embodiments, the terminal device may control a switch of the key light corresponding to the key identified by the key identifier such that the key light corresponding to the key is turned on. For example, the terminal device may close a switch of the key light corresponding to the key identified by the key identifier ID-E, a switch of the key light corresponding to the key identified by the key identifier ID-I, and a switch of the key light corresponding to the key identified by the key identifier ID-A, such that the key light corresponding to the key identified by the key identifier ID-E, the key light corresponding to the key identified by the key identifier ID-I, and the key light corresponding to the key identified by the key identifier ID-A are turned on.

In some embodiments, each key light may emit light with a preset color, and the terminal device may control the switch of the key light corresponding to the key identified by the key identifier such that the key light is turned on and emits the light with the preset color. For example, the terminal device controls the key light corresponding to each of the keys for characters “e”, “i” and “a” respectively, such that the key light corresponding to each of the keys for characters “e”, “i” and “a” is turned on and emits the light with the preset color.

In some embodiments, the key light corresponding to each key may emit light with multiple colors, and the color of the light may be controlled by a supply voltage of the key light. Thus, the terminal device may control the supply voltage of the key light corresponding to the key identified by the key identifier, such that the key light emits the light with the preset color. The supply voltage of the key light may be controlled in a manner known in the art, which is not elaborated herein. For example, the terminal device may control the supply voltage of the key light corresponding to each of the keys for characters “e”, “i” and “a” respectively, such that the key light corresponding to each of the keys for characters “e”, “i” and “a” is turned on and emits the light with the preset color.

In some embodiments, each key corresponds to a key light group, where each key light group includes at least one key light in a preset color, and each key light corresponds to one switch. The terminal device may control a switch corresponding to the key light group corresponding to the key identified by the key identifier to be turned on, such that the key light in the key light group emits the light with the preset color. For example, the terminal device may control the switch of the key light in the key light group corresponding to each of the keys for characters “e”, “i” and “a”, such that the key light corresponding to each of the keys for characters “e”, “i” and “a” emits the light with the preset color.

In sub-step 5042a, the terminal device causes key lights corresponding to other keys on the keyboard to be turned off.

In some embodiments, the terminal device may control switches of key lights corresponding to other keys on the keyboard, such that the key lights corresponding to the other keys on the keyboard are turned off. For example, the terminal device may open switches of key lights corresponding to keys on the keyboard other than the keys for characters “e”, “i” and “a”, such that the key lights corresponding to the keys on the keyboard other than the keys for characters “e”, “i” and “a” are turned off.

FIG. 5-4 is a schematic diagram 500d illustrating a key light control, according to an exemplary embodiment. In FIG. 5-4, a shaded pattern in a key represents that a key light corresponding to the key is turned on, and a solid white pattern in a key represents that a key light corresponding to the key is turned off. Referring to FIG. 5-4, the key light corresponding to each of the keys for characters “e”, “i” and “a” in the keyboard is turned on and emits the light with the preset color respectively, and the key lights corresponding to the keys in the keyboard other than the keys for characters “e”, “i” and “a” are turned off.

In some embodiments, keys on the keyboard may include function keys. The function keys may include keys provided with numbers, punctuation marks and space bars, which are not limited by the present disclosure. FIG. 5-5 is a flowchart of another method 550e for controlling a key light, according to an exemplary embodiment. Referring to FIG. 5-5, the method 550e may include the following steps.

In sub-step 5041b, the terminal device causes the key light corresponding to the key identified by the key identifier to emit light with a first preset color.

In sub-step 5042b, the terminal device causes key lights corresponding to the function keys to emit light with a second preset color.

In sub-step 5043b, the terminal device causes key lights corresponding to other keys on a keyboard to emit light with a third preset color.

The first preset color, the second preset color and the third preset color are different from each other.

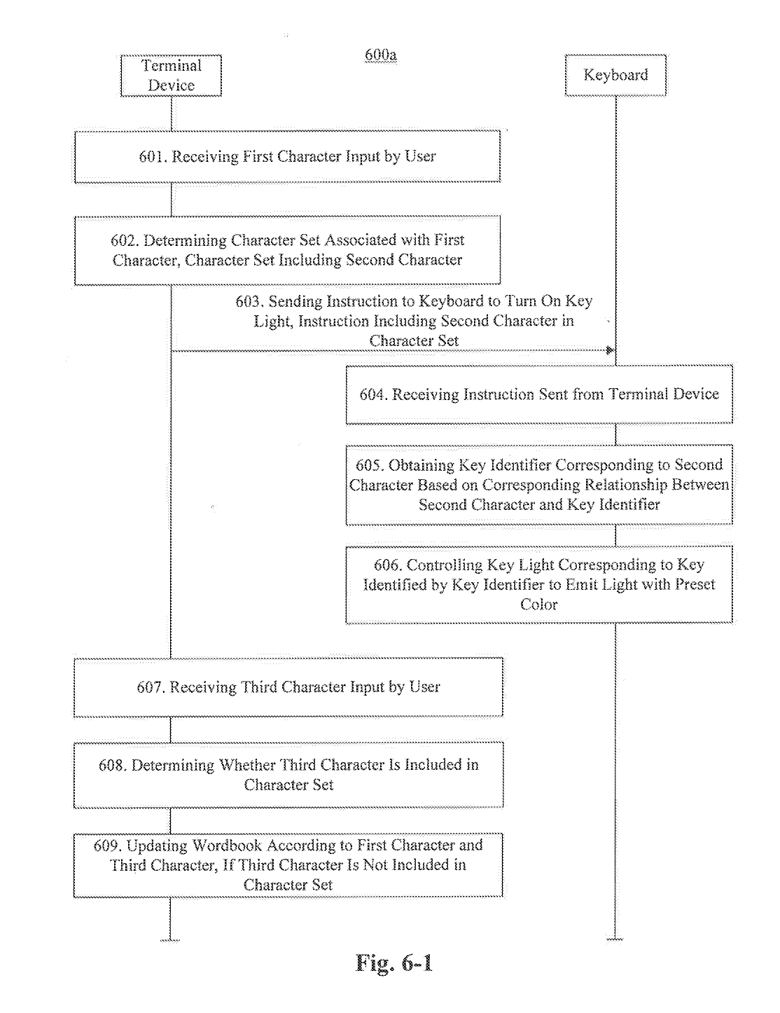

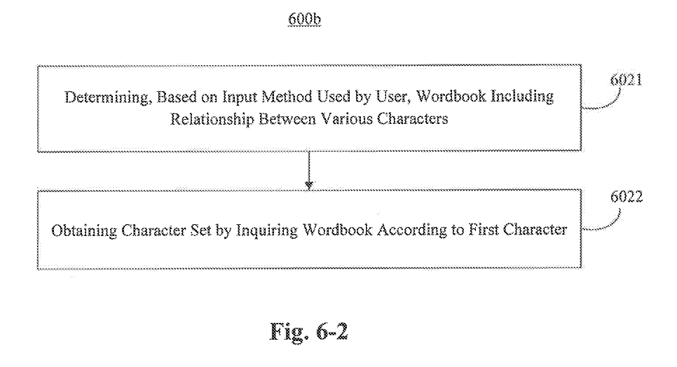

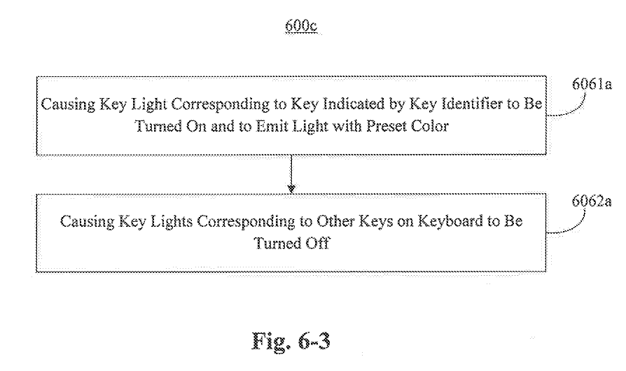

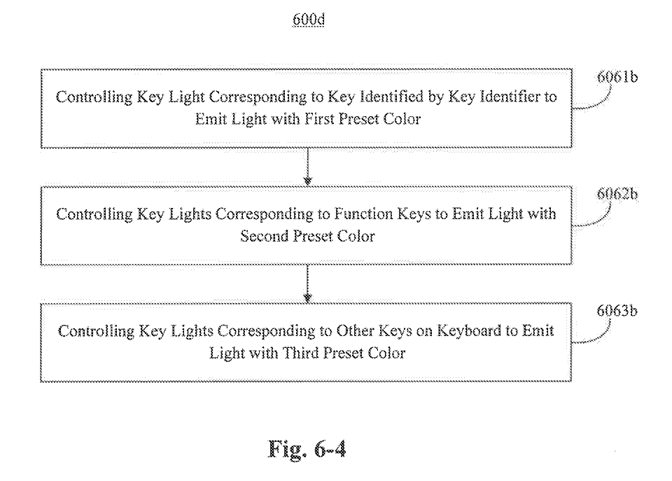

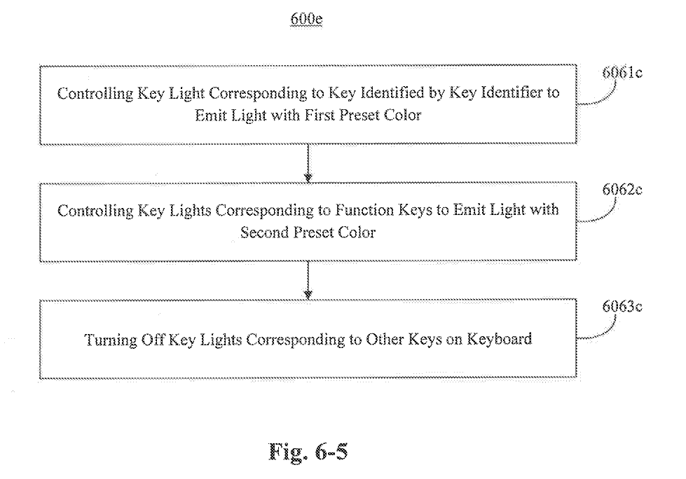

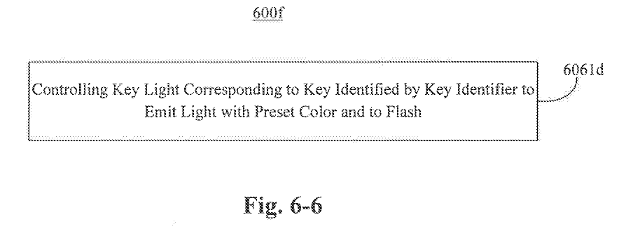

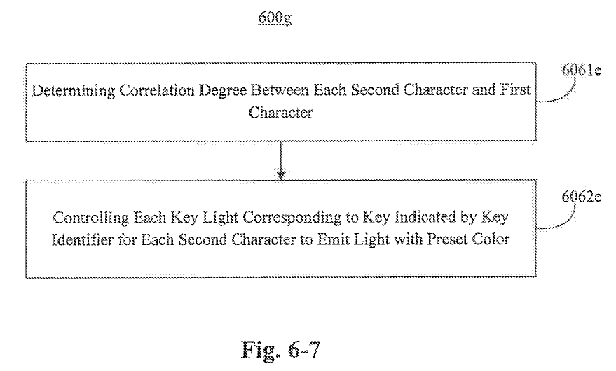

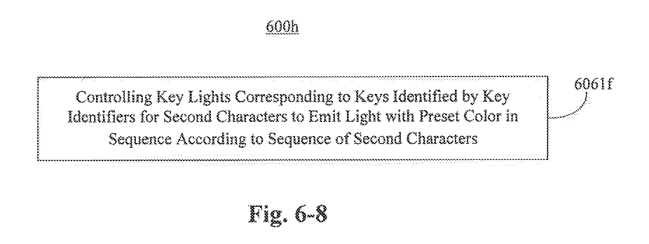

FIG. 5-6 is a schematic diagram 500f illustrating a key light control, according to an exemplary embodiment. In FIG. 5-6, the keys are filled with different patterns representing the first, second, and third preset color emitted by the corresponding key lights. Referring to FIG. 5-6, the key lights corresponding to the keys for characters “e”, “i” and “a” on the keyboard are turned on and emit the light with the first preset color, the key lights corresponding to the function keys on the keyboard are turned on and emit the light with the second preset color, and key lights corresponding to keys on the keyboard other than the keys for characters “e”, “i” and “a” and the function keys are turned on and emit light with a third preset color.

FIG. 5-7 is a flowchart of a method 500g for controlling a key light, according to an exemplary embodiment. Referring to FIG. 5-7 the method 500g may include following steps.

In sub-step 5041c, the terminal device causes the key light corresponding to the key identified by the key identifier to emit light with a first preset color.

In sub-step 5042c, the terminal device causes key lights corresponding to the function keys to emit light with a second preset color.

The first preset color is different from the second preset color.

In sub-step 5043c, the terminal device causes key lights corresponding to other keys on the keyboard to be turned off.

FIG. 5-8 is a schematic diagram 500h illustrating a key light control, according to an exemplary embodiment. In FIG. 5-8, the keys are filled with different patterns representing the first and second preset color emitted by the corresponding key lights, and the keys with no filling pattern represent that the key lights corresponding to the keys are turned off. Referring to FIG. 5-8, the key lights corresponding to the keys for characters “e”, “i” and “a” on the keyboard are turned on and emit the light with the first preset color, the key lights corresponding to the function keys on the keyboard are turned on and emit the light with the second preset color, and key lights corresponding to keys on the keyboard other than the keys for characters “e”, “i” and “a” and the function keys are turned off.

FIG. 5-9 is a flowchart of a method 500i for controlling a key light, according to an exemplary embodiment. Referring to FIG. 5-9, the method 500i may include following steps.

In sub-step 5041d, the terminal device causes the key light corresponding to the key identified by the key identifier to emit light with a preset color and to flash.

For example, the terminal device may control the key lights corresponding to the keys for characters “e”, “i” and “a” respectively to emit light with the preset color and to flash. The terminal device may switch on and off intermittently the switches of the key lights corresponding to the keys identified by the key identifiers, so as to flash the corresponding key lights.

FIG. 5-10 is a flowchart of a method 500j for controlling a key light, according to an exemplary embodiment. Referring to FIG. 5-10, the method 500j may include following steps.

In sub-step 5041e, the terminal device determines a correlation degree between each second character and the first character, where the character set includes a plurality of second characters.

For example, it can be seen in Table 2 above that the correlation degree between the second character and the first character may be recorded in the wordbook stored in the terminal device. As shown in Table 2, the correlation degree between the second character “e” and the first character “h” is 90%, the correlation degree between the second character “i” and the first character “h” is 60%, and the correlation degree between the second character “a” and the first character “h” is 20%.

In sub-step 5042e, the terminal device causes each key light corresponding to a key identified by a key identifier for each second character to emit light with a preset color, and controls the intensity of the light emitted by the key light based on the correlation degree between the first character and the corresponding second.

For example, after obtaining 3 correlation degrees, the terminal device may compare the 3 correlation degrees so as to determine a sequence of the at 3 correlation degrees, and then controls the key light corresponding to the key for a corresponding second character to emit the light with the preset color, and controls the intensity of the light emitted by the key light based on the correlation degree between the first character and the corresponding second character.

For example, it may be seen that the correlation degree between the second character “e” and the first character “h” is 90%, the correlation degree between the second character “i” and the first character “h” is 60%, and the correlation degree between the second character “a” and the first character “h” is 20%. Because 90% is greater than 60%, and 60% is greater than 20%, the terminal device may control the key lights corresponding to the keys for characters “e”, “i” and “a” respectively to emit the lights with the preset color, cause the intensity of the light emitted by the key light corresponding to the key for character “e” to be greater than that of the light emitted by the key light corresponding to the key for character “i”, and cause the intensity of the light emitted by the key light corresponding to the key for character “i” to be greater than that of the light emitted by the key light corresponding to the key for character “a”.

FIG. 5-11 is a schematic diagram 500k illustrating a key light control, according to an exemplary embodiment. In FIG. 5-11, the keys are filled with patterns of different densities representing the different intensity of the light emitted by the corresponding key lights. Referring to FIG. 5-11, the key lights corresponding to the keys on the keyboard for characters “e”, “i” and “a” are turned on and emit the lights with the preset color, the intensity of the light emitted by the key light corresponding to the key for character “e” is greater than that of the light emitted by the key light corresponding to the key for character “i”, and the intensity of the light emitted by the key light corresponding to the key for character “i” is greater than that of the light emitted by the key light corresponding to the key for character “a”.

FIG. 5-12 is a flowchart of a method 500l for controlling a key light, according to an exemplary embodiment. Referring to FIG. 5-12, the method 500l may include following steps.

In sub-step 5041f, the terminal device causes the key lights corresponding to the keys identified by the key identifiers for the second characters to emit light with a preset color in a sequence according to a sequence of the second characters.

In some embodiments, the second characters may be arranged based on the correlation degree between the second character and the first character from the greatest to the least. For example, the sequence of the second characters associated with the first character may be “e”, “i” and “a”, and the terminal device may control the key light corresponding to the key identified by the key identifier for each second character to emit light with the preset color in a sequence. For example, the terminal device may first control the key light corresponding to the key identified by the key identifier for character “e” to emit light with the preset color. After a preset period of time (such as 0.5 seconds), the terminal device may control the key light corresponding to the key identified by the key identifier for character “e” to be turned off, and control the key light corresponding to the key identified by the key identifier for character “i” to emit light with the preset color. Again after a preset period of time, the terminal device may control the key light corresponding to the key identified by the key identifier for character “i” to be turned off, and control the key light corresponding to the key identified by the key identifier for character “a” to emit light with the preset color, and so on.

Referring again to FIG. 5-1, in step 505, the terminal device receives a third character input by the user.

After the terminal device causes the key light corresponding to the key identified by the key identifier to emit the light with the preset color, the user may input character according to the prompt of the terminal device. For example, the user may operate the key on the keyboard for the third character to trigger a character input instruction. The character input instruction may include the third character, and the terminal device may receive and analyze the character input instruction to obtain the third character. The third character input by the user may be the second character in the character set or may not be the second character in the character set. If the third character input by the user is not the second character in the character set, the wordbook stored in the terminal device may not contain the word formed by the first character and the third character.

In step 506, the terminal device determines whether the third character is included in the character set.

After receiving the third character, the terminal device may determine whether the third character is included in the character set. The terminal device may determine whether the third character exists in the character set by searching the character set according to the third character.

For example, assuming the third character is “u”, the terminal device may search the character set according to the third character “u”. Since the characters in the character set are “e”, “i” and “a”, the terminal device may determine that the third character does not exist in the character set. As another example, assuming the third character is “a”, the terminal device may determine that the third character exists in the character set.

In step 507, the terminal device updates the wordbook according to the first character and the third character, if the third character is not included in the character set. In some embodiments, the terminal device may update the wordbook by communicating with the server or according to the user's operation, which is not limited by the present disclosure.

FIG. 5-13 is a flow diagram of a method 500m for updating a wordbook, according to an exemplary embodiment. Referring to FIG. 5-13, the method 500m may include following steps.

In sub-step 5071a, the terminal device sends an inquiry request to a server, the inquiry request including a term formed by the first character and the third character in a sequence. For example. When the first character is “h” and the third character is “u”, then the term to be inquired may be “hu”.

In sub-step 5072a, the server receives the inquiry request sent from the terminal device.

In sub-step 5073a, the server searches the wordbook in the server according to the inquiry request.

The wordbook of the server may be more comprehensive than the wordbook stored in the terminal device, and a term which does not exist in the wordbook of the terminal device may exist in the wordbook of the server. The server may search the wordbook in the server according to the inquiry request to obtain a correlation degree between the first character and the third character. For example, the correlation degree between the first character and the third character may be 10%.

In sub-step 5074a, the server generates an inquiry response including a correlation degree between the first character and the third character. For example, the server may generate the inquiry response after obtaining the correlation degree between the first character and the third character.

In sub-step 5075a, the server sends the inquiry response to the terminal device.

In sub-step 5076a, the terminal device receives the inquiry response sent from the server.

In sub-step 5077a, the terminal device records the correlation degree between the first character and the third character in the wordbook of the terminal device, if the inquiry response indicates that the term to be inquired exists in the wordbook in the server.

When the inquiry response includes the correlation degree between the first character and the third character, the terminal device may determine that the inquiry response indicates that the term to be inquired exists in the wordbook in the server. Accordingly, the terminal device may record the correlation degree between the first character and the third character in the wordbook to obtain an updated wordbook. For example, the updated wordbook is shown in Table 5 below.

TABLE 5
(Wordbook 3)

| First Character | Second Character | Correlation Degree | Potential Word |
|---|---|---|---|
| h | e | 90% | hello |
| | i | 60% | hi |
| | a | 20% | ha |
| | u | 10% | hu |
| a | m | 100% | am |
| | i | 80% | ai |
| | t | 50% | at |
| . . . | . . . | . . . | . . . |

In some embodiments, when the term to be inquired does not exist in the wordbook in the server, the terminal device may use the third character as the first character, and execute step 502 to step 505 described above in connection with FIG. 5-1, or the terminal device may also update the wordbook by using the method described below in connection with FIG. 5-14.

FIG. 5-14 is a flowchart of a method 500n for updating a wordbook, according to an exemplary embodiment. Referring to FIG. 5-14, the method 500n may include following steps.

In sub-step 5071b, the terminal device displays prompt information to the user for updating the wordbook. For example, the prompt information may be voice information or text information, which is not limited by the present disclosure. For example, the terminal device may display the prompt information as “A term consisting of the character h and the character u does not exist in the wordbook. Add the term to the wordbook?”. Alternatively, the terminal device may display a prompt box containing the prompt information and display a “confirm” button.

In sub-step 5072b, the terminal device receives an update instruction triggered by the user according to the prompt information, the update instruction including a term formed by the first character and the third character in a sequence.

After the terminal device displays the prompt information to the user, the user may trigger the update instruction according to the prompt information. For example, the user may click the “confirm” button in the prompt box to trigger the update instruction. The update instruction may include the term to be inquired consisting of the first character and the third character in a sequence. For example, when the first character is “h” and the third character is “u”, then the term to be inquired may be “hu”.

In sub-step 5073b, the terminal device records the correlation relationship between the first character and the third character in the wordbook.

After receiving the updating instruction triggered by the user, the terminal device may record the correlation relationship between the first character and the third character in the wordbook. For example, the terminal device may determine an initial correlation degree between the first character and the third character, and then adjust the correlation degree between the first character and the third character according to an input probability of the first character and the third character by the user.

FIG. 6-1 is another flow diagram of a method 600a for inputting a character, according to an exemplary embodiment. In this example, the terminal device is provided with a keyboard. In some implementations, the keyboard may be an external device of the terminal device and may communicate with a processor of the terminal device via an input/output interface of the terminal device. In other implementations, the keyboard may be an internal device of the terminal device and may be connected with the processor of the terminal device. Referring to FIG. 6-1, the method 600a may include following steps.

In step 601, the terminal device receives a first character input by a user. For example, the keyboard may receive the first character input by the user and transmit the first character to the processor of the terminal device.

In step 602, the terminal device determines a character set associated with the first character, the character set including a second character.

FIG. 6-2 is a flowchart of a method 600b for determining a character set, according to an exemplary embodiment. Referring to FIG. 6-2, the method 600b may include following steps.

In sub-step 6021, the terminal device determines, based on an input method used by the user, a wordbook including a relationship between various characters. In some implementations, the wordbook may be established by words input by the user.

In sub-step 6022, the terminal device obtains the character set by inquiring the wordbook according to the first character.

Step 601 and step 602 may be implemented in a similar manner as step 501 and step 502 discussed above in connection with FIG. 5-1, which will not be repeated herein.

Referring back to FIG. 6-1, in step 603, the terminal device sends an instruction to the keyboard to turn on a key light, the instruction including the second character in the character set. For example, the terminal device sends the instruction to the keyboard, such that the keyboard obtains a key identifier corresponding to the second character based on a corresponding relationship between the second character and the key identifier, and controls a key light corresponding to a key identified by the key identifier to emit light With a preset color, for prompting the user to input the second character.

In step 604, the keyboard receives the instruction sent from the terminal device.

When the terminal device sends the key light on instruction to the keyboard, the keyboard may receive the key light on instruction sent from the terminal device. The key light on instruction includes a second character in a second character set associated with a first character and determined according to the first character input by a user, and the second character set includes at least one second character.

In step 605, the keyboard obtains a key identifier corresponding to the second character based on a corresponding relationship between the second character and the key identifier.

Step 605 may be implemented in a similar manner as step 503 discussed above in connection with FIG. 5-1, which will not be repeated herein.

In step 606, the keyboard controls a key light corresponding to a key identified by the key identifier to emit light with a preset color, the light with the preset color for prompting the user to input character. For example, the light may be used for prompting the user to input the second character.

FIG. 6-3 is a flowchart of a method 600c for controlling a key light by a keyboard, according to an exemplary embodiment. Referring to FIG. 6-3, the method 600c may include following steps.

In sub-step 6061a, the keyboard causes the key light corresponding to the key identified by the key identifier to be turned on and to emit light with a preset color.

In sub-step 6062a, the keyboard causes key lights corresponding to other keys on the keyboard to be turned off.

In some embodiments, keys on the keyboard include function keys. The function keys may include keys provided with numbers, punctuation marks and space bars, which is not limited by the present disclosure. FIG. 6-4 is a flowchart of another method 600d for controlling a key light by a keyboard, according to an exemplary embodiment. Referring to FIG. 6-4, the method 600d may include following steps.

In sub-step 6061b, the keyboard controls the key light corresponding to the key identified by the key identifier to emit light with a first preset color.

In sub-step 6062b, the keyboard controls key lights corresponding to the function keys to emit light with a second preset color.

In sub-step 6063b, the keyboard controls key lights corresponding to other keys on the keyboard to emit light with a third preset color.

The first preset color, the second preset color and the third preset color may be different from each other.

FIG. 6-5 is a flowchart of another method 600e for controlling a key light by a keyboard, according to an exemplary embodiment. Referring to FIG. 6-5, the method 600e may include following steps.

In sub-step 6061c, the keyboard controls the key light corresponding to the key identified by the key identifier to emit light with a first preset color.

In sub-step 6062c, the keyboard controls key lights corresponding to the function keys to emit light with a second preset color. The second preset color may be different from the first preset color.

In sub-step 6063c, the keyboard turns off key lights corresponding to other keys on the keyboard.

FIG. 6-6 is a flowchart of another method 600f for controlling a key light by a keyboard, according to an exemplary embodiment. Referring to FIG. 6-6, the method 600f may include following steps.

In sub-step 6061d, the keyboard controls the key light corresponding to the key identified by the key identifier to emit light with a preset color and to flash.

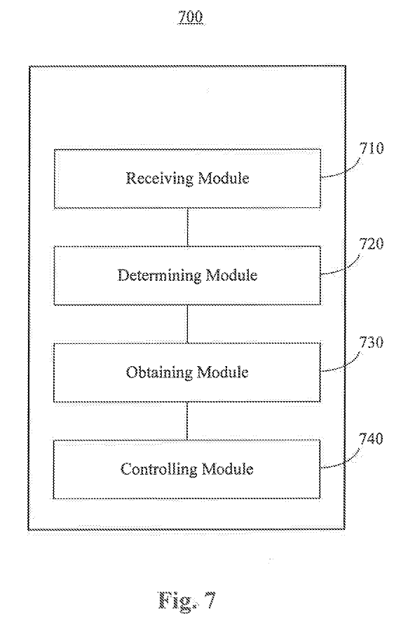

FIG. 6-7 is a flowchart of another method 600g for controlling a key light by a keyboard, according to an exemplary embodiment. Referring to FIG. 6-7, the method 600g may include following steps.

In sub-step 6061e, the keyboard determines a correlation degree between each second character and the first character, where the character set includes a plurality of second characters.

In some implementations, the wordbook is stored in the terminal device, and the instruction sent from the terminal device to the keyboard may include the correlation degree between the second character and the first character for the keyboard to determine the correlation degree between each second character and the first character.

In sub-step 6062e, the keyboard controls each key light corresponding to a key identified by a key identifier for each second character to emit light with a preset color.

In some embodiments, the intensity of the light emitted by the key light is positively correlated with the correlation degree between the corresponding second character and the first character.

In some embodiments, the character set includes a plurality of second characters arranged in a sequence. For example, the plurality of second characters may be arranged based on the correlation degree between each second character and the first character from the greatest to the least, and the keyboard may control the key lights corresponding to the second characters to emit light with the preset color in a sequence according to the sequence of the second characters. FIG. 6-8 is a flowchart of another method 600h for controlling a key light by a keyboard, according to an exemplary embodiment. Referring to FIG. 6-8, the method 600h may include following steps.

In sub-step 6061f, the keyboard controls the key lights corresponding to the keys identified by the key identifiers for the second characters to emit light with a preset color in a sequence according to the sequence of the second characters.

Step 606 may be implemented in a similar manner as step 504 discussed above in connection with FIG. 5-1, which will not be repeated herein.

Referring back to FIG. 6-1, in step 607, the terminal device receives a third character input by the user. For example, the keyboard may receive the third character input by the user and transmit the third character to the processor of the terminal device.

In step 608, the terminal device determines whether a the third character is included in the character set.

In step 609, the terminal device updates the wordbook according to the first character and the third character, if the third character is not included in the character set.

Steps 607-609 may be implemented in a similar manner as steps 505-507 discussed above in connection with FIGS. 5-1, 5-13, and 5-14, which will not be repeated herein.

FIG. 7 is a block diagram of an apparatus 700 for inputting a character, according to an exemplary embodiment. The apparatus 700 may be implemented as all or a part of a terminal device 110 shown in FIG. 1-1. Referring to FIG. 7, the apparatus 700 includes a receiving module 710, a determining module 720, an obtaining module 730, and a controlling module 740.

The receiving module 710 is configured to receive a first character input by a user.

The determining module 720 is configured to determine a character set associated with the first character, the character set including a second character.

The obtaining module 730 is configured to obtain a key identifier corresponding to the second character based on a corresponding relationship between the second character and the key identifier.

The controlling module 740 is configured to cause a key light corresponding to a key identified by the key identifier to emit light with a preset color. For example, the light may be used for prompting the user to input the second character.

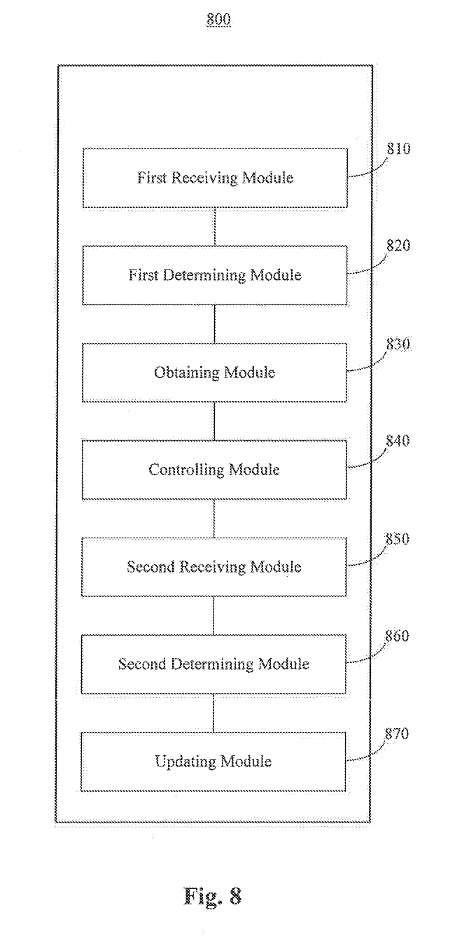

FIG. 8 is a block diagram of another apparatus 800 for inputting a character, according to an exemplary embodiment. The apparatus 800 may be implemented as all or a part of a terminal device 110 shown in FIG. 1-1. Referring to FIG. 8, the apparatus 800 includes a first receiving module 810, a first determining module 820, an obtaining module 830, a controlling module 840, a second receiving module 850, a second determining module 860, and an updating module 870.

The first receiving module 810 is configured to receive a first character input by a user.

The first determining module 820 is configured to determine a character set associated with the first character, the character set including a second character.

The obtaining module 830 is configured to obtain a key identifier corresponding to the second character based on a corresponding relationship between the second character and the key identifier.

The controlling module 840 is configured to control a key light corresponding to a key identified by the key identifier to emit light with a preset color.

In some embodiments, the first determining module 820 is further configured to determine, based on an input method used by the user, a wordbook for recording a correlation relationship between different characters, and obtain the character set by inquiring the wordbook according to the first character.

The second receiving module 850 is configured to receive a third character input by the user.

The second determining module 860 is configured to determine whether the third character is included in the character set.

The updating module 870 is configured to update the wordbook according to the first character and the third character, if third character is not included in the character set.

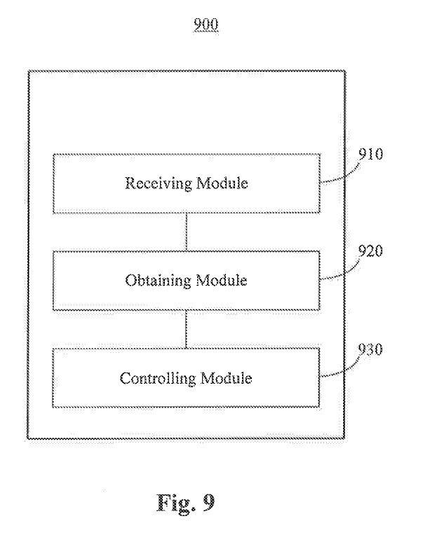

FIG. 9 is a block diagram of another apparatus 900 for inputting a character, according to an exemplary embodiment. The apparatus 900 may be implemented as a terminal device. Referring to FIG. 9, the apparatus 900 includes a receiving module 910, an obtaining module 920, and a controlling module 930.

The receiving module 910 is configured to receive an instruction to turn on a key light, the instruction including a second character in a character set associated with a first character input by a user.

The obtaining module 920 is configured to obtain a key identifier corresponding to the second character based on a corresponding relationship between the second character and the key identifier.

The controlling module 930 is configured to cause a key light corresponding to a key identified by the key identifier to emit light with a preset color.

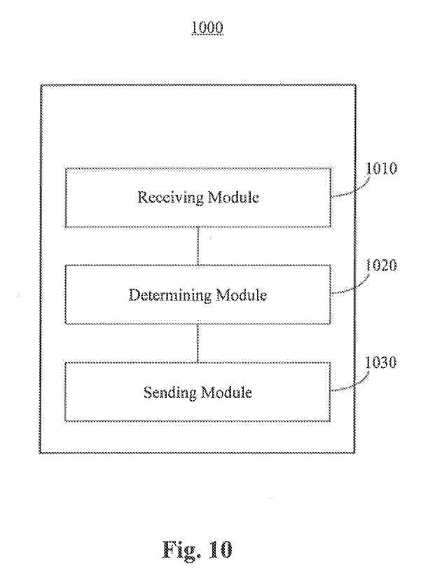

FIG. 10 is a block diagram of another apparatus 1000 for inputting a character, according to an exemplary embodiment. The apparatus 1000 may be implemented as a terminal device. Referring to FIG. 10, the apparatus 1000 includes a receiving module 1010, a determining module 1020, and a sending module 1030.

The receiving module 1010 is configured to receive a first character input by a user.

The determining module 1020 is configured to determine a character set associated with the first character, the character set including a second character.

The sending module 1030 is configured to send an on instruction to turn on a key light, the instruction including the second character for a keyboard to obtain a key identifier corresponding to the second character and control a key light corresponding to a key identified by the key identifier to emit light with a preset color.

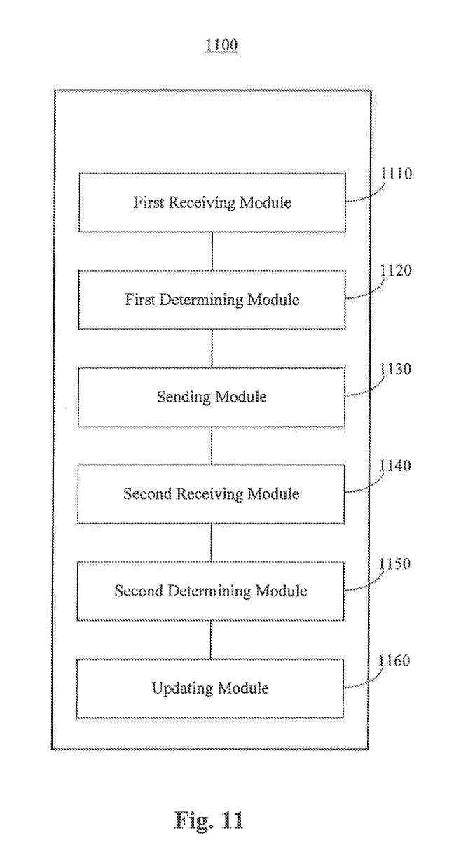

FIG. 11 is a block diagram of another apparatus 1100 for inputting a character, according to an exemplary embodiment. The apparatus 1100 may be implemented as all or a part of a terminal device. Referring to FIG. 11, the apparatus 1100 includes a first receiving module 1110, a first determining module 1120, a sending module 1130, a second receiving module 1140, a second determining module 1150, and an updating module 1160.

The first receiving module 1110 is configured to receive a first character input by a user.

The determining module 1120 is configured to determine a character set associated with the first character, the character set including a second character.

The sending module 1130 is configured to send an instruction to turn on a key light, the instruction including the second character in the character set, such that a keyboard may obtain a key identifier corresponding to the second character based on a corresponding relationship between the second character and the key identifier, and control a key light corresponding to a key identified by the key identifier to emit light with a preset color.

The second receiving module 1140 is configured to receive a third character input by the user.

The second determining module 1150 is configured to determine whether the third character is included in the character set.

The updating module 1160 is configured to update the wordbook according to the first character and the third character, if the third character is not included in the character set.

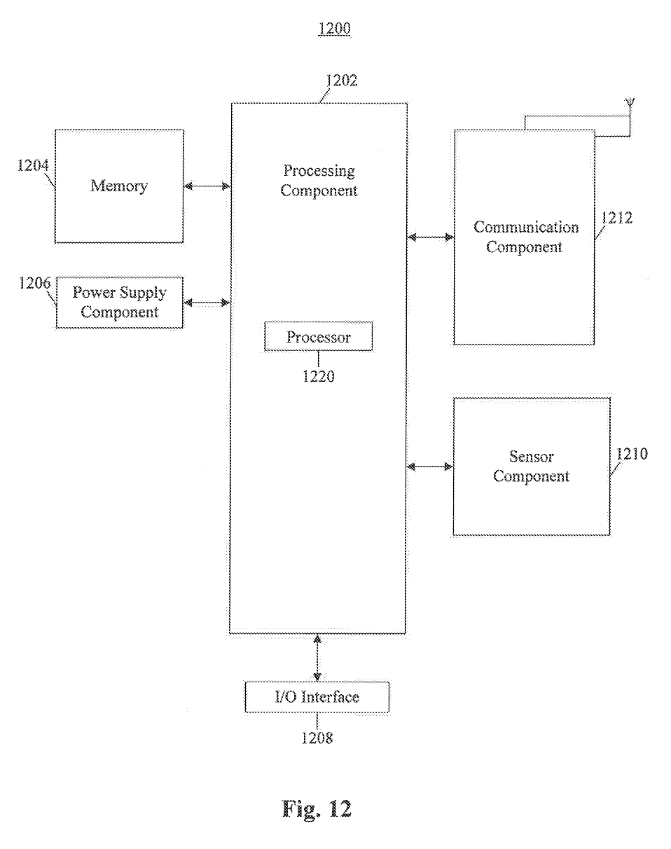

FIG. 12 is a block diagram of a device 1200 for inputting a character, according to an exemplary embodiment. The device 1200 may be provided a keyboard disposed in a terminal device, or a keyboard external to a terminal device. For example, the device 1200 may be a keyboard integrated with a processor, and the keyboard may be disposed in a cell phone, a mobile phone, a digital broadcast terminal, a messaging device, a gaming console, a medical device, exercise equipment, a personal digital as assistant, a desktop computer, a portable laptop computer, a notebook computer, a smart television, a smart wearable device and the like.

Referring to FIG. 12, the device 1200 may include one or more of the following components: a processing component 1202, a memory 1204, a power supply component 1206, an input/output (I/O) interface 1208, a sensor component 1210, and a communication component 1212. The person skilled in the art should appreciate that the structure of the device 1200 as shown in FIG. 12 does not intend to limit the device 1200. The device 1200 may include more or less components or combine some components or other different components.

The processing component 1202 typically controls overall operations of the device 1200, such as the operations associated with communications, processing and recording operations. The processing component 1202 may include one or more processors 1220 to execute instructions to perform all or part of the steps in the above described methods. Moreover, the processing component 1202 may include one or more modules which facilitate the interaction between the processing component 1202 and other components.

The memory 1204 is configured to store various types of data to support the operation of the device 1200. Examples of such data include instructions for any applications or methods operated on the device 1200, contact data, phonebook data, messages, images, video, etc. The memory 1204 is also configured to store programs and modules. The processing component 1202 performs various functions and data processing by operating programs and modules stored in the memory 1204. The memory 1204 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 1206 is configured to provide power to various components of the device 1200. The power supply component 1206 may include a power management system, one or more power sources, and any other components associated with the generation, management, and distribution of power in the device 1200.

The I/O interface 1208 provides an interface between the processing component 1202 and peripheral interface modules. The peripheral interface may be a keyboard.

The sensor component 1210 includes one or more sensors to provide status assessments of various aspects of the device 1200. For instance, the sensor component 1210 may detect an on/off state of the device 1200, relative positioning of components, e.g., the display and the keypad, of the device 1200, a change in position of the device 1200 or a component of the device 1200, a presence or absence of user contact with the device 1200, an orientation or an acceleration/deceleration of the device 1200, and a change in temperature of the device 1200. The sensor component 1210 may include a proximity sensor configured to detect the presence of nearby objects without any physical contact. The sensor component 1210 may also include a light sensor, such as a CMOS or CCD image sensor, for use in imaging applications. In some embodiments, the sensor component 1210 may also include an accelerometer sensor, a gyroscope sensor, a magnetic sensor, a pressure sensor, or a temperature sensor.

The communication component 1212 is configured to facilitate communication, wired or wirelessly, between the device 1200 and other devices. The device 1200 can access a wireless network based on a communication standard, such as WiFi, 2G, or 3G, or a combination thereof. In one exemplary embodiment, the communication component 1212 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1204, executable by the processor 1220 in the device 1200, for performing the above-described methods. For example, the non-transitory computer-readable storage medium may be a ROM, a RAM, a CD-ROM, a magnetic tape, a floppy disc, an optical data storage device, and the like.

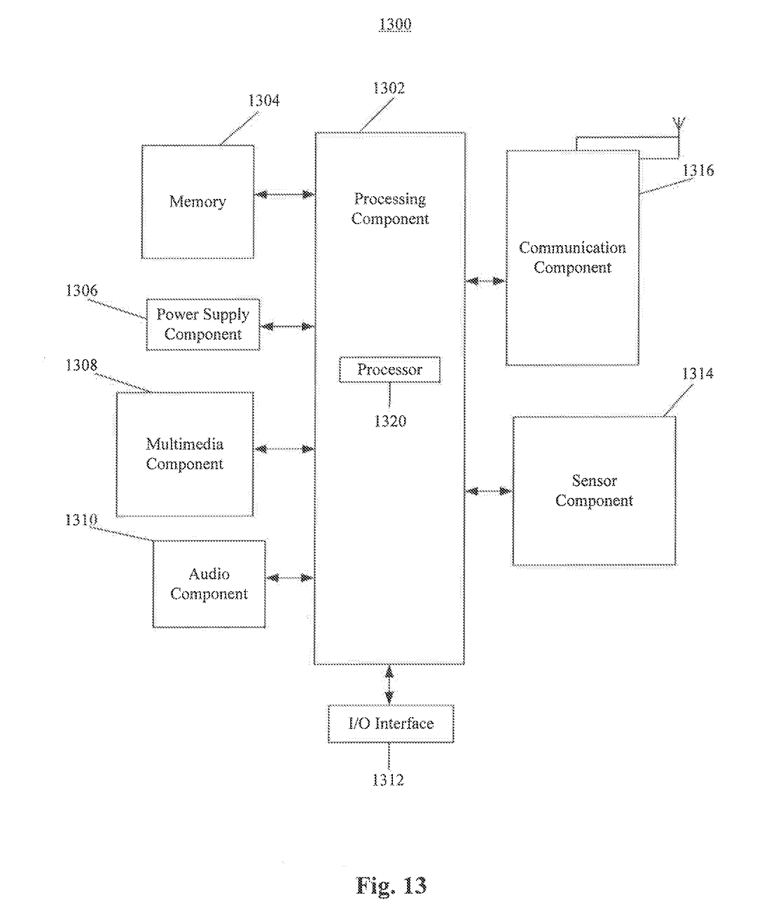

FIG. 13 is a block diagram of another device 1300 for inputting a character, according to an exemplary embodiment. For example, the device 1300 may be a provided as a terminal device, such as a cell phone, a mobile phone, a digital broadcast terminal, a messaging device, a gaming console, a medical device, exercise equipment, a personal digital as assistant, a desktop computer, a portable laptop computer, a notebook computer, a smart television, a smart wearable device and the like.

Referring to FIG. 13, the device 1300 may include one or more of the following components: a processing component 1302, a memory 1304, a power supply component 1306, a multimedia component 1308, an audio component 1310, an input/output (I/O) interface 1312, a sensor component 1313, and a communication component 1316. The person skilled in the art should appreciate that the structure of the device 1300 as shown in FIG. 13 does not intend to limit the device 1300. The device 1300 may include more or less components or combine some components or other different components.

The processing component 1302 typically controls overall operations of the device 1300, such as the operations associated with display, telephone calls, data communications, camera operations, and recording operations. The processing component 1302 may include one or more processors 1320 to execute instructions to perform all or part of the steps in the above described methods. Moreover, the processing component 1302 may include one or more modules which facilitate the interaction between the processing component 1302 and other components. For instance, the processing component 1302 may include a multimedia module to facilitate the interaction between the multimedia component 808 and the processing component 1302.

The memory 1304 is configured to store various types of data to support the operation of the device 1300. Examples of such data include instructions for any applications or methods operated on the device 1300, contact data, phonebook data, messages, images, video, etc. The memory 1304 is also configured to store programs and modules. The processing component 1302 performs various functions and data processing by operating programs and modules stored in the memory 1304. The memory 1304 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 1306 is configured to provide power to various components of the device 1300. The power supply component 1306 may include a power management system, one or more power sources, and any other components associated with the generation, management, and distribution of power in the device 1300.

The multimedia component 1308 includes a screen configured to provide an output interface between the device 1300 and a user. In some embodiments, the screen may include a liquid crystal display (LCD) and/or a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action.

The audio component 1310 is configured to output and/or input audio signals. For example, the audio component 1310 includes a microphone configured to receive an external audio signal when the device 1300 is in an operation mode, such as a call mode, a recording mode, and a voice recognition mode. The received audio signal may be further stored in the memory 1304 or transmitted via the communication component 1316. In some embodiments, the audio component 1310 further includes a loud speaker to output audio signals.

The I/O interface 1312 is configured to provide an interface between the processing component 1302 and peripheral interface modules, such as a keyboard, a click wheel, buttons, and the like. The buttons may include, but are not limited to, a home button, a volume button, a starting button, and a locking button.

The sensor component 1310 includes one or more sensors to provide status assessments of various aspects of the device 1300. For instance, the sensor component 1310 may detect an on/off state of the device 1300, relative positioning of components, e.g., the display and the keypad, of the device 1300, a change in position of the device 1300 or a component of the device 1300, a presence or absence of user contact with the device 1300, an orientation or an acceleration/deceleration of the device 1300, and a change in temperature of the device 1300. The sensor component 1310 may include a proximity sensor configured to detect the presence of nearby objects without any physical contact. The sensor component 1310 may also include a light sensor, such as a CMOS or CCD image sensor, for use in imaging applications. In some embodiments, the sensor component 1310 may also include an accelerometer sensor, a gyroscope sensor, a magnetic sensor, a pressure sensor, or a temperature sensor.

The communication component 1316 is configured to facilitate communication, wired or wirelessly, between the device 1300 and other devices. The device 1300 can access a wireless network based on a communication standard, such as WiFi, 2G, or 3G, or a combination thereof. In one exemplary embodiment, the communication component 1316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1304, executable by the processor 1320 in the device 1300, for performing the above-described methods. For example, the non-transitory computer-readable storage medium may be a ROM, a RAM, a CD-ROM, a magnetic tape, a floppy disc, an optical data storage device, and the like.

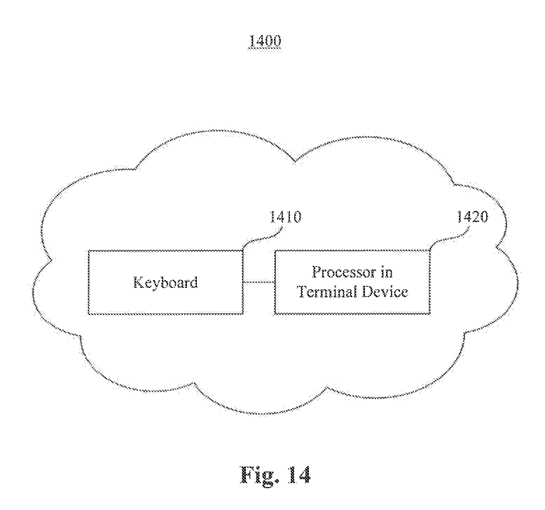

FIG. 14 is a block diagram of a system 1400 for inputting a character, according to an exemplary embodiment. Referring to FIG. 14, the system 1400 includes a keyboard 1410 and a processor 1420 in a terminal device.

For example, the keyboard 1410 may include the apparatus 900 described above in connection with FIG. 9, and the processor 1420 in the terminal device may include the apparatus 1000 or 1100 described above in connection with FIG. 10 and FIG. 11.

As another example, the keyboard 1410 may be implemented as the device 1200 described above in connection with FIG. 12, and the terminal device may be implemented as the device 1300 described above in connection with FIG. 13.

It should be understood by those skilled in the art that the above described modules can each be implemented through hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being identified by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for inputting a character, comprising:
receiving a first character input by a user;
determining a character set associated with the first character, the character set including a second character;
obtaining a key identifier corresponding to the second character based on a corresponding relationship between the second character and the key identifier; and
causing a key light corresponding to a key identified by the key identifier to emit light with a preset color.

2. The method according to claim 1, wherein determining the character set comprises:
determining a wordbook based on an input method used by the user, the wordbook including a relationship between a plurality of characters; and
obtaining the character set based on the wordbook and the first character.

3. The method according to claim 2, further comprising:
receiving a third character input by the user;
determining whether the third character is included in the character set; and
updating the wordbook according to the first character and the third character, if the third character is not included in the character set.

4. The method according to claim 3, wherein updating the wordbook comprises:
sending an inquiry request to a server, the inquiry request including a term formed by the first character and the third character in a sequence;
receiving an inquiry response sent from the server, the inquiry response generated by the server based on another wordbook stored in the server; and
recording a correlation relationship between the first character and the third character in the wordbook, if the inquiry response indicates that the term exists in the other wordbook in the server.

5. The method according to claim 3, wherein updating the wordbook comprises:
displaying prompt information to the user for updating the wordbook;
receiving an update instruction triggered by the user, the update instruction including a term formed by the first character and the third character in a sequence; and
recording a correlation relationship between the first character and the third character in the wordbook.

6. The method according to claim 1, wherein the character set includes a plurality of characters, the method further comprising:
determining a correlation degree between the first character and each of the plurality of characters; and
causing a plurality of key lights corresponding to the plurality of characters, respectively, to emit light with the preset color;
wherein an intensity of the light emitted by each of the plurality of key lights is associated with a correlation degree between the first character and a character corresponding to the each of the plurality of key lights.

7. The method according to claim 1, wherein the character set includes a plurality of characters arranged in a sequence, the method further comprising:
causing a plurality of key lights corresponding to the plurality of characters, respectively, to emit light with the preset color in a sequence according to the sequence of the plurality of characters.

8. A method for inputting a character, comprising:
receiving an instruction to turn on a key light, the instruction including a second character, and the second character being included in a character set associated with a first character input by a user;
obtaining a key identifier corresponding to the second character based on a corresponding relationship between the second character and the key identifier; and
causing a key light corresponding to a key identified by the key identifier to emit light with a preset color.

9. The method according to claim 8, further comprising:
causing a plurality of key lights corresponding to a plurality of keys on a keyboard to be turned off, the plurality of keys being different from the key identified by the key identifier.

10. The method according to claim 8, wherein the preset color is a first preset color, the method further comprising:
causing a plurality of key lights corresponding to function keys on a keyboard to emit light with a second preset color; and
causing another plurality of key lights corresponding to a plurality of keys on the keyboard to emit light with a third preset color, the plurality of keys being different from the key and the function keys;
wherein the first preset color, the second preset color, and the third preset color are different.

11. The method according to claim 8, wherein the preset color is a first preset color, the method further comprising:
causing a plurality of key lights corresponding to function keys on a keyboard to emit light with a second preset color, wherein the second preset color is different from the first preset color; and
causing another plurality of key lights corresponding to a plurality of keys on the keyboard to be turned off, the plurality of keys being different from the key and the function keys.

12. The method according to claim 8, wherein the character set includes a plurality of characters, the method further comprising:
determining a correlation degree between the first character and each of the plurality of characters; and
causing a plurality of key lights corresponding to the plurality of characters, respectively, to emit light with the preset color;
wherein an intensity of the light emitted by each of the plurality of key lights is associated with the correlation degree between the first character and a character corresponding to the each of the plurality of key lights.

13. The method according to claim 8, wherein the character set includes a plurality of characters arranged in a sequence, the method further comprising:
causing a plurality of key lights corresponding to the plurality of characters, respectively, to emit light with the preset color according to the sequence of the plurality of characters.

14. A device for inputting a character, comprising:
a processor; and
a memory for storing instructions executable by the processor,
wherein the processor is configured to:
receive a first character input by a user;
determine a character set associated with the first character, the character set including a second character;
obtain a key identifier corresponding to the second character based on a corresponding relationship between the second character and the key identifier; and
cause a key light corresponding to a key identified by the key identifier to emit light with a preset color.

15. The device according to claim 14, wherein the processor is further configured to:
determine a wordbook based on an input method used by the user, the wordbook including a correlation relationship between a plurality of characters; and
obtain the character set based on the wordbook and the first character.

16. The device according to claim 15, wherein the processor is further configured to:
receive a third character input by the user;
determine whether the third character is included in the character set; and
update the wordbook according to the first character and the third character, if the third character is not included in the character set.

17. The device according to claim 16, wherein the processor is further configured to:
send an inquiry request to a server, the inquiry request including a term formed by the first character and the third character in a sequence;
receive an inquiry response sent from the server, the inquiry response generated by the server based on another wordbook stored in the server by; and
record a correlation relationship between the first character and the third character in the wordbook, if the inquiry response indicates that the term exists in the other wordbook in the server.

18. The device according to claim 16, wherein the processor is further configured to:
display prompt information to the user for updating the wordbook;
receive an update instruction triggered by the user, the update instruction including a term formed by the first character and the third character in a sequence; and
record a correlation relationship between the first character and the third character in the wordbook.

19. A device for inputting a character, comprising:
a processor; and
a memory for storing instructions executable by the processor,
wherein the processor is configured to:
receive an instruction to turn on a key light, the instruction including a second character, and the second character being included in a character set associated with a first character input by a user;
obtain a key identifier corresponding to the second character based on a corresponding relationship between the second character and the key identifier; and
cause a key light corresponding to a key identified by the key identifier to emit light with a preset color.

20. The device according to claim 19, wherein the character set includes a plurality of characters, and wherein the processor is further configured to:
determine a correlation degree between the first character and each of the plurality of characters; and
cause a plurality of key lights corresponding to the plurality of characters, respectively, to emit light with the preset color;
wherein an intensity of the light emitted by each of the plurality of key lights is associated with the correlation degree between the first character and a character corresponding to the each of the plurality of key lights.

21. The device according to claim 19, wherein the character set includes a plurality of characters arranged in a sequence, and wherein the processor is further configured to:
cause a plurality of key lights corresponding to the plurality of characters, respectively, to emit light with the preset color according to the sequence of the plurality of characters.
